(19) United States
(12) Patent Application Publication
(10) Pub. No.: US 2007/0030646 A1
(43) Pub. Date: Feb. 8, 2007

(54) External connection box and a case body thereof for a storage device

(76) Inventor: Chun-Yu Hsu, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/194,647

(22) Filed: Aug. 2, 2005

(51) Int. Cl. G06F 1/20

(52) U.S. Cl. 361/687; 361/685

(57) ABSTRACT

An external connection box and a case body thereof are for receiving a storage device therein. The external connection box for a storage device has a case body, a front cover, and a rear cover. The case body has an outer casing and at least one metal inner plate. The outer casing forms a receiving space therein. The at least one metal inner plate is disposed at an inner surface of the outer casing. The at least one metal inner plate has a plurality of resilient fins, and the resilient fins extend into the receiving space. As such, the case body of the external connection box for a storage device of the present invention has a heat dissipating function, an EMI shielding function, a reinforcing function, and a cushioning function.

### BACKGROUND OF THE INVENTION

1. Field of the Invention

The present invention relates to an external connection box and a case body thereof, and more particularly, to an external connection box and a case body thereof for receiving a storage device such as a hard disk or a memory module therein.

2. Background of the Invention

Storage devices (such as hard disks or memory modules) are important peripheral devices for computers as they store a large amount of electronic data therein. In order to easily carry a storage device, manufacturers use an external connection box for receiving the storage device therein, to protect the storage device, to improve the external appearance of the storage device and to ensure that the storage device operates efficiently and stably.

Furthermore, as a consequence of technological progress and the demand of users, the speed of storage devices is getting faster and their capacity is getting larger.

A conventional external connection box for a storage device includes a supporting body and an upper cover. The supporting body forms a receiving space therein for receiving a storage device (such as a hard disk) therein. The upper cover slidably connects to the supporting body to prevent the storage device from being dropped.

The supporting body of the above conventional external connection box for a storage device may be made of an aluminum alloy to facilitate heat dissipation. However, when the storage device is received in the receiving space, a metal element on a surface of the storage device (such as the metal outer casing) is unable to sufficiently contact the supporting body. Consequently, the heat dissipating function of the external connection box is not good, and the storage device operates inefficiently. In addition, the external connection box does not have an EMI (Electromagnetic Interfering) shielding function, so it is unable to ensure that the storage device operates stably. Furthermore, aluminum alloy is expensive and unpleasant to look at.

Moreover, there is a gap between the storage device and the external connection box. When the external connection box is shaken or impacted by an external force, the storage device is affected, too. This causes the electronic data stored in the storage device to be damaged.

Accordingly, as discussed above, the conventional external connection box for a storage device still has some drawbacks that could be improved upon. The present invention aims to resolve the drawbacks in the prior art.

### SUMMARY OF THE INVENTION

The primary object of the invention is therefore to specify an external connection box and a case body thereof for a storage device. The case body is modularized in order to have a heat dissipating function and an EMI (Electromagnetic Interfering) shielding function. In this way, the operating efficiency and stability of the storage device received in the case body are improved and the case body can be used with any type of circuit module connected to the storage device.

Another object of the invention is to specify an external connection box and a case body thereof for a storage device. The case body is easily manufactured, aesthetically pleasing and strong. In this way, the quality of the external connection box is improved and the cost thereof is reduced.

Still another object of the invention is to specify an external connection box and a case body thereof for a storage device. The case body has a cushioning function. In this way an impact by an external force upon the storage device will be less likely to damage the data stored therein.

According to the invention, these objects are achieved via a case body of an external connection box for a storage device. The case body of the external connection box comprises an outer casing and at least one metal inner plate. The outer casing forms a receiving space therein. The at least one metal inner plate is disposed at an inner surface of the outer casing. The at least one metal inner plate has a plurality of resilient fins, and the resilient fins extend into the receiving space.

According to the invention, the objects are achieved via an external connection box for a storage device. The external connection box for a storage device comprises an outer casing, at least one metal inner plate, a front cover, and a rear cover. The outer casing forms a receiving space therein. The receiving space defines a front opening and a rear opening at a front and a rear thereof, respectively. The at least one metal inner plate is disposed at an inner surface of the outer casing. The at least one metal inner plate has a plurality of resilient fins, and the resilient fins extend into the receiving space. The front cover is disposed at the front opening of the outer casing. The rear cover is disposed at the rear opening of the outer casing.

When a storage device is received in the outer casing, the resilient fins of the at least one metal inner plate sufficiently and resiliently contact a metal element on a surface of the storage device to dissipate heat and provide an EMI shielding function. The outer casing and the at least one metal inner plate are modularized so that they can be used with any type of circuit module connected to the storage device.

In a preferred embodiment, the outer casing is made of plastic material or rubber material. As the outer casing is made of materials that are easily formed, and the at least one metal inner plate is easily formed, the case body is easily manufactured, aesthetically pleasing and strong.

The resilient fins of the at least one metal inner plate are able to absorb shocks, so that the case body has a cushioning function.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an exploded perspective view of a first embodiment of an external connection box for a storage device of the present invention;

FIG. 2 is an assembly perspective view of a first embodiment of an external connection box for a storage device of the present invention;

FIG. 3 is another assembly perspective view of a first embodiment of an external connection box for a storage device of the present invention;

FIG. 4 is a partial cross-sectional side view showing a storage device received in a first embodiment of an external connection box for a storage device of the present invention;

FIG. 5 is a schematic view of square resilient fins of a metal inner plate of an external connection box for a storage device of the present invention;

FIG. 6 is a schematic view of triangular resilient fins of a metal inner plate of an external connection box for a storage device of the present invention;

FIG. 7 is an exploded perspective view of a second embodiment of an external connection box for a storage device of the present invention; and

FIG. 8 is an exploded perspective view of a third embodiment of an external connection box for a storage device of the present invention.

### DETAILED DESCRIPTION OF THE EMBODIMENTS

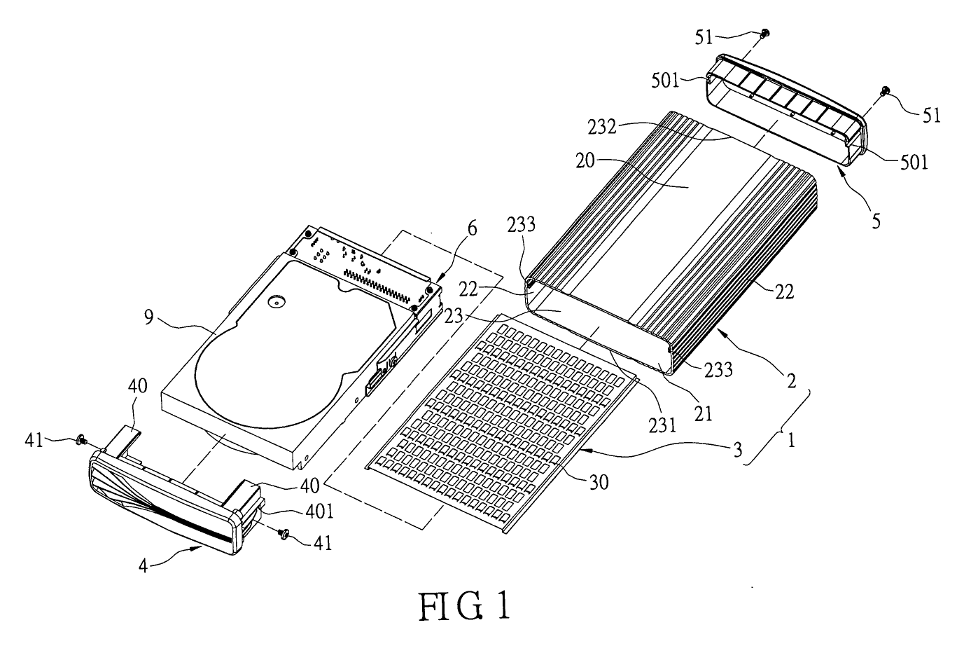

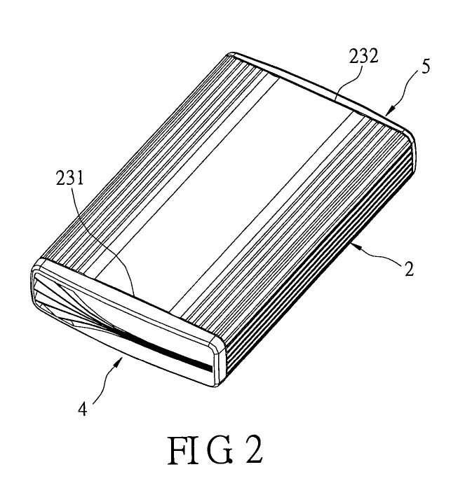

FIGS. 1-3 show a first embodiment of the present invention. The present invention provides an external connection box and a case body thereof for a storage device. The external connection box for a storage device comprises a case body 1, a front cover 4, and a rear cover 5. The case body 1 of the external connection box for a storage device comprises an outer casing 2 and at least one metal inner plate 3.

The outer casing 2 is made of materials that are easily formed, such as plastic material or rubber material, so that the outer casing 2 is easily manufactured, aesthetically pleasing and strong. The outer casing 2 has an upper plate portion 20, a bottom plate portion 21, and two lateral plate portions 22. The two lateral plate portions 22 are connected between the upper plate portion 20 and the bottom plate portion 21. The outer casing 2 forms a receiving space 23 therein, and the receiving space 23 defines a front opening 231 and a rear opening 232 at a front and a rear thereof, respectively. The outer casing 2 has a guiding rail 233 disposed at an inner surface thereof. The guiding rail 233 has a guiding function and a reinforcing function. In the first embodiment, the outer casing 2 further has a plurality of concave lines (not labeled) disposed at an outer surface thereof. The concave lines have a reinforcing function and a beautifying effect.

The at least one metal inner plate 3 may be made via stamping a blank of metal plate, so that it is easily formed and the cost thereof is reduced. The at least one metal inner plate 3 is disposed at an inner surface of the outer casing 2 via an insert-molding or assembly method. In the first embodiment, the at least one metal inner plate 3 is disposed at an inner surface of the upper plate portion 20. The at least one metal inner plate 3 has a plurality of resilient fins 30, and the resilient fins 30 extend into the receiving space 23. The resilient fins 30 may be arranged regularly or irregularly to obtain different heat dissipating functions, EMI (Electromagnetic Interfering) shielding functions, reinforcing functions, and cushioning functions.

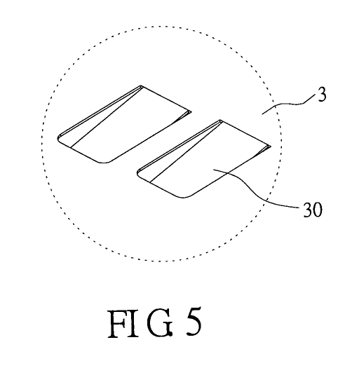

Referring to FIG. 5, the resilient fins 30 of the at least one metal inner plate 3 include a plurality of square resilient fins.

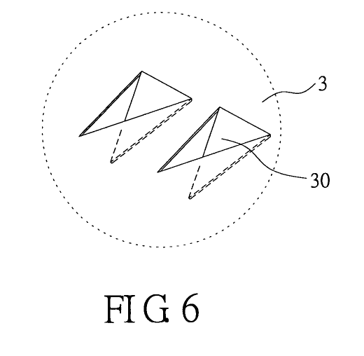

Referring to FIG. 6, the resilient fins 30 of the at least one metal inner plate 3 include a plurality of triangular resilient fins.

As shown in FIG. 5 and FIG. 6, the resilient fins 30 may have any type of shape to obtain different heat dissipating functions, EMI (Electromagnetic Interfering) shielding functions, reinforcing functions, and cushioning functions. Therefore, the shape of the resilient fins 30 is not restricted to the above embodiments.

The front cover 4 is disposed at the front opening 231 of the outer casing 2. In the first embodiment, the front cover 4 has at least one lateral arm 40 (FIG. 1 shows two lateral arms 40), the at least one lateral arm 40 has a guiding slot 401, and the guiding slot 401 couples with the guiding rail 233 of the outer casing 2.

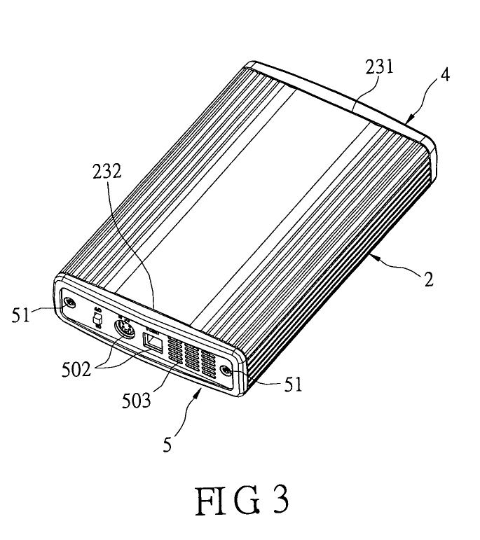

The rear cover 5 is disposed at the rear opening 232 of the outer casing 2. In the first embodiment, the rear cover 5 has a guiding slot 501, and the guiding slot 501 couples with the guiding rail 233 of the outer casing 2. In FIG. 3, the rear cover 5 has several apertures 502 and several heat dissipation holes 503.

The external connection box for a storage device of the present invention further comprises a circuit module 6. In the first embodiment, the circuit module 6 includes a circuit board (not labeled) and several connection ports (not labeled) for being connected to a storage device 9 (such as a hard disk or a memory module), electrically connecting to the storage device 9, and for connecting to an outside electronic equipment (such as a computer). The external connection box for a storage device of the present invention further comprises at least one fastening element 41 and at least one fastening element 51.

When the storage device 9 is installed in the outer casing 2 of the external connection box for a storage device of the present invention, the circuit module 6 is firstly connected to the storage device 9 and electrically connected to the storage device 9. The at least one fastening element 41 penetrates through the at least one lateral arm 40 of the front cover 4 and is fixed to the storage device 9. As such, the storage device 9, the circuit module 6, and the front cover 4 are assembled together.

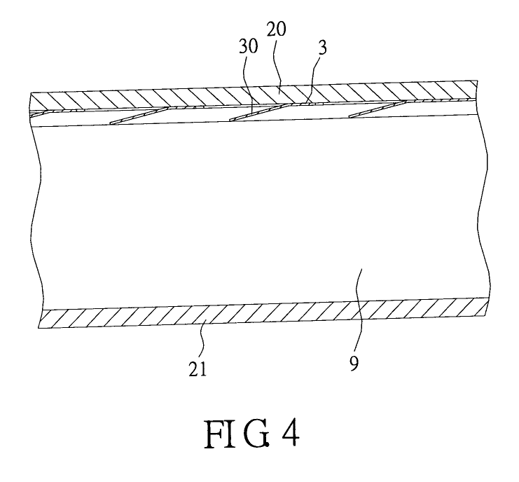

Next, the circuit module 6 and the storage device 9 are received in the receiving space 23 of the outer casing 2. The guiding rail 233 of the outer casing 2 guides the guiding slot 401 of the front cover 4, so that the front cover 4 is assembled at the front opening 231 of the outer casing 2. Referring to FIG. 4, the resilient fins 30 of the at least one metal inner plate 3 sufficiently and resiliently contact a metal element on a surface of the storage device 9 (such as a metal outer casing thereof) to have a heat dissipating function and an EMI (Electromagnetic Interfering) shielding function.

Next, the at least one fastening element 51 penetrates through the rear cover 5 and is fixed to the circuit module 6. As shown in FIG. 3, the circuit module 6 has elements, such as connection ports, that respectively correspond to the apertures 502 of the rear cover 5. The heat dissipation holes 503 enable air to flow naturally to reduce the temperature of the storage device 9 and the circuit module 6.

The resilient fins 30 are wide and have a large area, so the at least one metal inner plate 3 has a better heat dissipating function and a better EMI shielding function. As such, the operating efficiency and stability of the storage device 9 are improved.

The outer casing 2 and the at least one metal inner plate 3 are modularized to form the case body 1 that is independent from the circuit module 6 assembled on the storage device 9. In this way the case body 1 is capable of being used with any type of circuit module 6. When the external connection box for a storage device of the present invention is shaken or impacted by an external force, the resilient fins 30 of the at least one metal inner plate 3 are able to absorb the shock, so as to avoid damaging the electronic data stored in the storage device 9.

The external connection box for a storage device of the present invention may further include a fan (not shown) to create airflow, so as to improve the heat dissipating function.

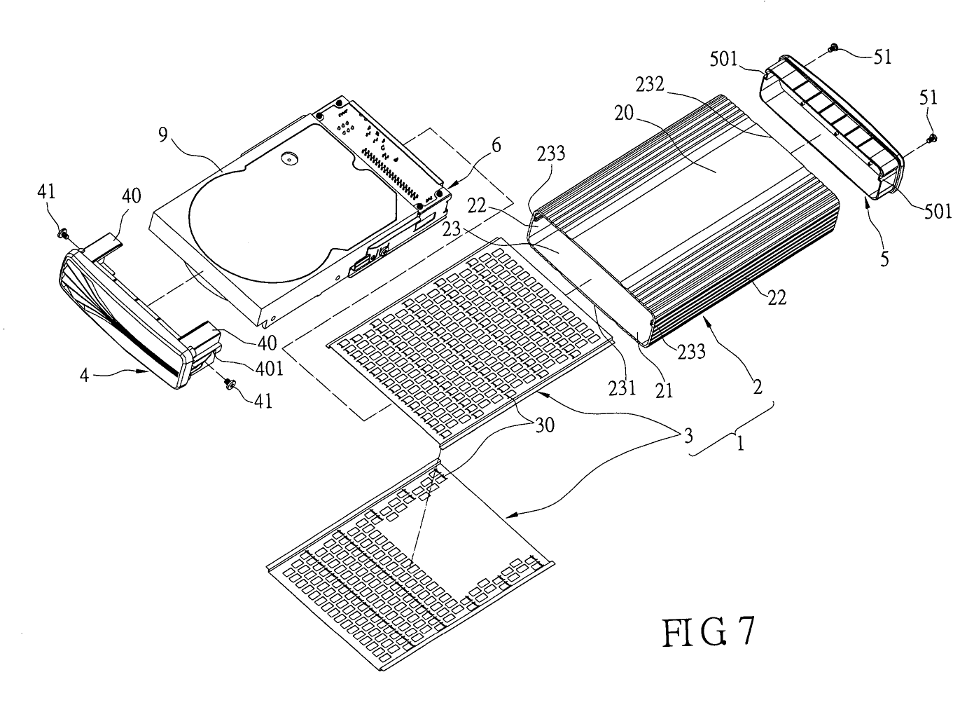

FIG. 7 shows a second embodiment of the external connection box for a storage device of the present invention. The difference between the second embodiment and the first embodiment is that the at least one metal inner plate 3 has a number of two in the second embodiment. In the second embodiment, the two metal inner plates 3 are disposed at an inner surface of the upper plate portion 20 and an inner surface of the bottom plate portion 21. In this way the resilient fins 30 contact a top and a bottom of the metal outer casing of the storage device 9, and contact grounding metal elements of a circuit board (not shown) disposed at a bottom of the storage device 9.

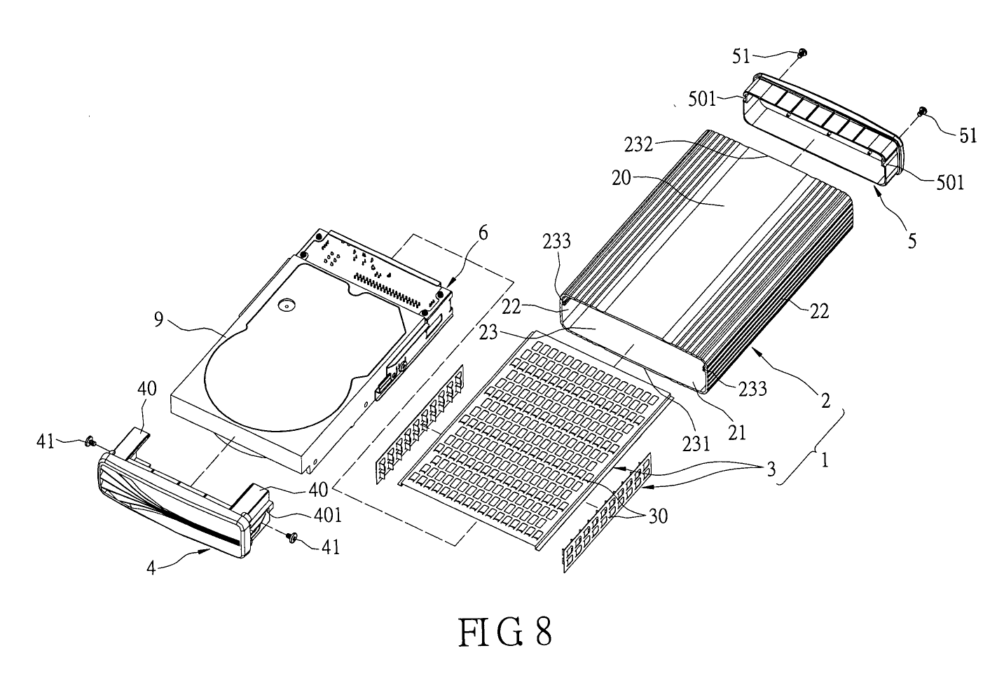

FIG. 8 shows a third embodiment of the external connection box for a storage device of the present invention. The difference between the third embodiment and the first embodiment is that the at least one metal inner plate 3 has a number of three in the third embodiment. In the third embodiment, the three metal inner plates 3 are disposed at an inner surface of the upper plate portion 20 and inner surfaces of the two lateral plate portions 22. In this way the resilient fins 30 contact a top and two sides of the metal outer casing of the storage device 9. As shown in FIG. 1, FIG. 7, and FIG. 8, the positions of the metal inner plates 3 are designed according to the metal elements on the surface of the storage device 9. Meanwhile, the shapes and the arrangement of the resilient fins 30 are designed to have different heat dissipating functions, EMI shielding functions, reinforcing functions, and cushioning functions. The at least one metal inner plate 3 may also be integrally made in one piece.

As indicated above, the external connection box and a case body thereof for a storage device of the present invention has the following advantages:

(1) The resilient fins of the at least one metal inner plate sufficiently and resiliently contact a metal element on a surface of the storage device so that they have a heat dissipating function and an EMI (Electromagnetic Interfering) shielding function. In this way the operating efficiency and stability of the storage device are improved.

(2) The outer casing and the at least one metal inner plate are modularized so that they can be used with any type of circuit module connected to the storage device, so that the use of the case body is more inclusive.

(3) The outer casing is made of materials that are easily formed, and the at least one metal inner plate is easily formed, so that the case body is easily manufactured, aesthetically pleasing and strong. In this way the quality of the external connection box is improved and the cost thereof is reduced.

(4) The resilient fins of the at least one metal inner plate are able to absorb shocks, so that the case body has a cushioning function to avoid damage caused by an external force that impact upon the storage device.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A case body of an external connection box for a storage device, comprising:
an outer casing forming a receiving space therein; and
at least one metal inner plate disposed at an inner surface of the outer casing, the at least one metal inner plate having a plurality of resilient fins, and the resilient fins extending into the receiving space.

2. The case body of an external connection box as claimed in claim 1, wherein the outer casing has an upper plate portion, a bottom plate portion, and two lateral plate portions, the two lateral plate portions are connected between the upper plate portion and the bottom plate portion, and the at least one metal inner plate is disposed at an inner surface of the upper plate portion.

3. The case body of an external connection box as claimed in claim 1, wherein the outer casing has an upper plate portion, a bottom plate portion, and two lateral plate portions, the two lateral plate portions are connected between the upper plate portion and the bottom plate portion, the at least one metal inner plate has a number of two, and the two metal inner plates are disposed at an inner surface of the upper plate portion and an inner surface of the bottom plate portion.

4. The case body of an external connection box as claimed in claim 1, wherein the outer casing has an upper plate portion, a bottom plate portion, and two lateral plate portions, the two lateral plate portions are connected between the upper plate portion and the bottom plate portion, the at least one metal inner plate has a number of three, and the three metal inner plates are disposed at an inner surface of the upper plate portion and inner surfaces of the two lateral plate portions.

5. The case body of an external connection box as claimed in claim 1, wherein the resilient fins of the at least one metal inner plate include a plurality of square resilient fins.

6. The case body of an external connection box as claimed in claim 1, wherein the resilient fins of the at least one metal inner plate include a plurality of triangular resilient fins.

7. The case body of an external connection box as claimed in claim 1, wherein the resilient fins of the at least one metal inner plate are arranged irregularly.

8. The case body of an external connection box as claimed in claim 1, wherein the outer casing has a guiding rail disposed at an inner surface thereof.

9. The case body of an external connection box as claimed in claim 1, wherein the outer casing is made of plastic material.

10. The case body of an external connection box as claimed in claim 1, wherein the outer casing is made of rubber material.

11. An external connection box for a storage device, comprising:
an outer casing forming a receiving space therein, the receiving space defining a front opening and a rear opening at a front and a rear thereof, respectively;
at least one metal inner plate disposed at an inner surface of the outer casing, the at least one metal inner plate having a plurality of resilient fins, and the resilient fins extending into the receiving space;
a front cover disposed at the front opening of the outer casing; and a rear cover disposed at the rear opening of the outer casing.

12. The external connection box as claimed in claim 11, wherein the outer casing has an upper plate portion, a bottom plate portion, and two lateral plate portions, the two lateral plate portions are connected between the upper plate portion and the bottom plate portion, and the at least one metal inner plate is disposed at an inner surface of the upper plate portion.

13. The external connection box as claimed in claim 11, wherein the outer casing has an upper plate portion, a bottom plate portion, and two lateral plate portions, the two lateral plate portions are connected between the upper plate portion and the bottom plate portion, the at least one metal inner plate has a number of two, and the two metal inner plates are disposed at an inner surface of the upper plate portion and an inner surface of the bottom plate portion.

14. The external connection box as claimed in claim 11, wherein the outer casing has an upper plate portion, a bottom plate portion, and two lateral plate portions, the two lateral plate portions are connected between the upper plate portion and the bottom plate portion, the at least one metal inner plate has a number of three, and the three metal inner plates are disposed at an inner surface of the upper plate portion and inner surfaces of the two lateral plate portions.

15. The external connection box as claimed in claim 11, wherein the outer casing has a guiding rail disposed at an inner surface thereof, the front cover has a guiding slot, and the guiding slot couples with the guiding rail.

16. The external connection box as claimed in claim 11, wherein the outer casing has a guiding rail disposed at an inner surface thereof, the rear cover has a guiding slot, and the guiding slot couples with the guiding rail.

17. The external connection box as claimed in claim 11, comprising at least one fastening element, wherein the front cover has at least one lateral arm, and the at least one fastening element penetrates through the at least one lateral arm and is fixed to a storage device.

18. The external connection box as claimed in claim 11, comprising a circuit module and at least one fastening element, wherein the circuit module is electrically connected to a storage device, the circuit module and the storage device are received in the receiving space, and the at least one fastening element penetrates through the rear cover and is fixed to the circuit module.
